(19) United States
(12) Patent Application Publication
(10) Pub. No.: US 2010/0318661 A1
(43) Pub. Date: Dec. 16, 2010

(54) METHOD OF RESERVATION WITH GUARANTEE OF LATENCY AND OF BIT RATE IN A TIME SLOT DYNAMIC ALLOCATION NETWORK

(75) Inventor: Domininique Heurguier, Le Perreux Sur Marne (FR)

Correspondence Address: STROOCK & STROOCK & LAVAN LLP, 180 MAIDEN LANE, NEW YORK, NY, 10038, US

(73) Assignee: THALES, Neuilly Sur Seine (FR)

(21) Appl. No.: 12/744,007

(22) PCT Filed: Nov. 24, 2008
(86) PCT No.: PCT/EP08/66083

§ 371 Date: May 20, 2010

(30) Foreign Application Priority Data
Nov. 23, 2007 (FR) 07/08221

(51) Int. Cl. G06F 15/16

(52) U.S. Cl. 709/226

(57) ABSTRACT

A resource reservation method with guaranteed service in terms of minimum bit rate and maximum access time at radio network nodes using time slots each associated with an individual bit rate for sending and transmitting data. A node includes a protocol layer that sends a reservation request to a MAC layer. The source node introduces into the format of the Path and Resv messages of the RSVP protocol fields corresponding to the maximum duration of the time slot observed on the current path in the Adspec reservation request of the Path message, the number of radio nodes crossed in the object of the Path message, and the maximum waiting time for the time slot in the Rspec object of the Resv message corresponding to the response to the reservation request. The MAC layer reserves the number of time slots needed to satisfy the service guarantee recorded in the reservation request.

### CROSS REFERENCE TO RELATED APPLICATIONS

This application is the U.S. National Phase application under 35 U.S.C. §371 of International Application No. PCT/EP2008/066083, filed Nov. 24, 2008, and claims the benefit of French Patent Application No. 0708221, filed Nov. 23, 2007, all of which are incorporated by reference herein. The International Application was published on May 28, 2009 as WO 2009/065958.

### FIELD OF THE INVENTION

The invention relates to ad hoc radio networks with time division multiple access TFDMA. It targets more particularly the resource reservation capability including the end-to-end bit rate and latency constraints, one or other of these constraints potentially predominating. An ad hoc network is defined as a network in which the constituent nodes are mobile, that is to say that the number of nodes in the network is likely to change over time.

It also applies to multiple-channel systems with time and frequency division multiple access, TDMA, the radio networks using an OFDMA (Orthogonal Frequency Division Multiple Access) orthogonal frequency modulation, and to any other system which uses a dynamic allocation scheme instead of a fixed allocation scheme.

For information, in the description, the following messages and objects of the RSVP protocol are used:
the Tspec object of the PATH message describes the application's traffic profile,
the Adspec object describes, among other things, the characteristics of the path and in particular the maximum bandwidth available on the path,
the Rspec object of the RESV reservation message contains the bandwidth to be reserved for the data stream.

The sender sends a PATH message to a recipient to which data must be transmitted, the recipient or receiver responds by sending a reservation message RESV containing the bandwidth to be reserved for the routers via which the message or data packets are relayed.

### BACKGROUND OF THE INVENTION

The TDMA radio networks generally use static allocations. The allocation is either totally fixed (cyclical frame with one slot for each node), or predefined for a given configuration.

The new radio systems are beginning to take account of service quality, but they do not yet support overall resource reservation with guaranteed service from end-to-end in terms of bit rate and latency. For example, they do not support the service guarantee over IP (Internet Protocol) protocols such as the “Reservation Protocol services” resource reservation protocol, better known by the abbreviation RSVP.

Regarding resource reservation, the current radio systems known to the Applicant with time division multiple access like TDMA cannot guarantee both the minimum bit rate and a maximum latency from end-to-end.

A recent method described in the Patent Application FR 06 11279 filed by the Applicant and entitled “Method for reserving and dynamically allocating time slots in a network with guaranteed service” applies the RSVP protocol to a TDMA network with the following implementation restrictions: medium access control MAC packets of fixed size for the sessions and a reservation adapted to the applications with latency constraints predominating over bit rate constraints. In practice, this method does not make it possible to optimize resource consumption and is uneconomical, particularly for applications with predominant bit rate constraints.

The invention relates to a medium access control MAC level method for dynamically allocating radio resource time slots, better know as slots, with session packets or packets reserved for a session in an application, having a variable size and a service guarantee, that can be used equally in applications requiring a predominant latency constraint and/or a predominant bit rate constraint to be observed. Two types of traffic are differentiated: elastic traffic and session traffic. Session traffic corresponds, for example, to continuous multimedia streams (voice and video) and real-time data streams for which a strong service guarantee (bit rate and latency) is desired. Elastic traffic corresponds, for example, to a file transfer.

### SUMMARY OF THE INVENTION

The present invention is based notably on the invention described in the Patent Application FR 06 11279 mentioned previously which makes it possible to implement dynamic session slot allocations locally, that is to say without recourse to centralized management in normal operation. The method described in this prior art is based on an explicit assignment of the session “slots” to one or more nodes and on a concept of reservation of these “slots”. A “slot” assigned to a node can be freely reserved by this node to satisfy a resource reservation request. As seen from a given node, the set of unreserved session “slots” forms a group or pool of resources from which the node can potentially draw.

In the case of an application with predominant latency constraint, the method described in the Patent Application FR 06 11279 makes it possible to decline an overall reservation from end-to-end with guaranteed latency, of RSVP type in latency management mode, better known by the abbreviation OPWA, standing for “One Pass With Advertising”, in the MAC layer when a slot consists of a number NPS of MAC packets of fixed size.

In this case, the parameters C and D of the Adspec message have the values:

C=BR.Ts/NPS=size of an MAC packet

D=additional transmission time

With the following MAC parameters (partly defined previously):
BR: bit rate of the TDMA channel,
N: number of network nodes,
K: number of physical slots for a node,
NPS: number of MAC packets per physical slot,
H: number of physical slots taken by the node concerned,
Ts: duration of a physical slot,
m: number of MAC packets reserved.

The RSVP request is then declined in the MAC layer as follows:
maximum transmission delay required: τ=C/R
minimum bit rate required: R=r

The present invention uses a novel approach which comprises a reservation of the variable size session packets, the size of a session packet being defined notably by the maximum size of a packet of the application, plus the MAC level encapsulation data such as the header, and the explicit management of radio access delay at the reservation protocol level.

In an embodiment, the invention relates to a resource reservation method with guaranteed service in terms of minimum bit rate Dmin and maximum access time Amax at the n nodes crossed in a radio network using time slots or slots Di each associated with an individual bit rate Deli for sending and transmitting data, a node of the network comprising a protocol layer and an MAC network access layer, characterized in that it comprises at least the following steps:

for a given node, the protocol layer of said node sends a reservation request to the MAC layer of said node, the source node sending the data introduces into the format of the PATH and RESV messages of the RSVP protocol:
a field Ts corresponding to the maximum duration of the time slot observed on the current path in the Adspec reservation request of the PATH message, transmitted from the source to a recipient,
a field n concerning the number of radio nodes crossed in the Adspec object of the PATH message,
a field τ giving the maximum waiting time for the time slot in the Rspec object of the RESV message corresponding to the response to the PATH reservation request sent by the recipient to the source node,
the MAC layer of said node reserves the number of time slots Di needed to satisfy the service guarantee recorded in the reservation request.

### BRIEF DESCRIPTION OF DRAWINGS

Other features and advantages of the present invention will become better apparent from reading the following description of an example given as a nonlimiting illustration, with appended figures which represent:

FIG. 1, the principle of resource reservation,

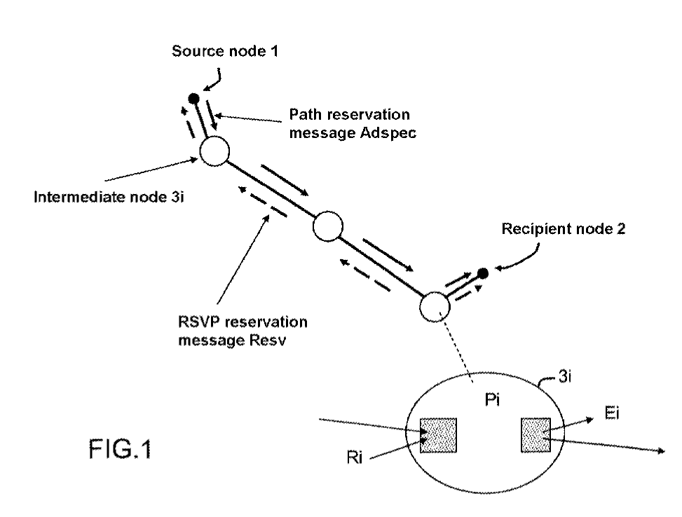

FIGS. 2A and 2B, a frame format and a time slot in the case of a TDMA single-source application, and

FIG. 3, the exchanges between the IP and MAC TDMA layers, for the example given.

### DETAILED DESCRIPTION OF THE INVENTION

In order to better understand the principle implemented in the method according to the invention, the description is given as an illustration and is by no means limiting, for a TDMA ad hoc radio network in which all the nodes are independent and can play the same role. A node 1 will act as the source at a given instant, a second node 2, the recipient of the message or of the data, and a number of intermediate nodes 3i. For this, all the nodes (source node and recipient nodes) are each equipped with a processor Pi suitable for implementing the steps of the method according to the invention. They are also provided with radio means, sender and receiver Ei, Ri, with which to transmit the messages to other nodes and receive messages from these other nodes, the recipient node has means for receiving this request and sending in turn a path reservation message, the nodes using time slots to send and transmit data. An intermediate node comprises an MAC layer and a protocol layer and means for implementing the method according to the invention. Such equipment is known to those skilled in the art and will not be described in detail. A few reminders are given for the terminology used and the context of the invention in the preamble to the explanation of the method and of the system according to the invention.

### Terminology

The architecture of a radio frame consists of 4 layered elements which will convey the useful data, a useful data unit potentially being a packet of the application, for example an IP packet:
Individual MAC resource: MAC packet (encapsulation packet at the MAC level of an application packet),
Time slot: better known by the term “slot”,
Basic frame: BF,
Frame: F

These various elements are detailed hereinbelow.

### MAC Packet

The MAC packet is a basic data structure at the MAC level. It has a variable size. For a given session, its size is fixed and is determined by the maximum size of an application packet.

### Time Slot, Basic Frame and Frame

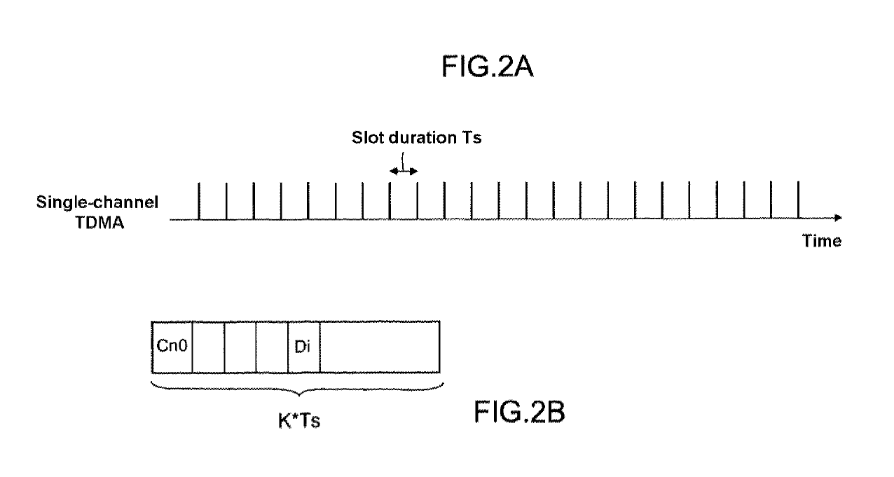

The basic frame and the “slots” are illustrated in FIGS. 2A and 2B

Cn: control slot for the node n
Di: slot of the basic frame (other than the control slot)
Ts: slot duration
K: number of slots making up the basic frame
T_{BF}: duration of the basic frame with T_{BF}=K*Ts

Each basic frame contains K slots. The first slot Cn₀ in each basic frame is called “control slot”. This is a “fixed slot” permanently allocated to the node n.

The slots can be divided into three classes:
The control slots Cni used to transmit the MAC level signaling (signaling packets needed for the operation of the MAC level services such as discovery of neighbors and frame synchronization). These services and their implementation are known to those skilled in the art and will not be detailed again.
The “elastic” slots used to transmit the elastic data: generally a subset K of Di slots (in which i=1 . . . K−1) are allocated statistically to nodes, in order to transmit elastic data. Thus, Dij, (in which j=1 . . . P) slots are reserved for the transmission of elastic data (each node thus having P slots evenly distributed in the frame). Hereto, the term “elastic” is a term usually known to those skilled in the art and unambiguously designates data.
The “session” slots used to transmit session packets. These slots can support elastic data. They are reserved for a given session.

If the control slot Cni and the elastic slots Dij are counted, the N.(K-1-P) remaining slots in the overall frame constitute session slots which can be dynamically allocated so as to transmit the session packets. The unassigned session slots are grouped together in a set or pool and are divided up between all the nodes of the network. This means that any node that needs to satisfy a required service quality can use one or more slots from the set or pool.

A slot “Di” (in which i=1 . . . . K−1) of the overall frame can be assigned permanently to a node (elastic slot), temporarily (session slot allocated to a node or to several nodes in a space reuse case), or form part of the pool of available session slots.

There are as many basic frames as there are nodes in the network. The frame F consists of all the basic frames. If the network is formed by N nodes, the frame F structure consists of N basic frames BF. The duration T_{F} of the frame has the value T_{F}=N*T_{BF}=N*K*Ts.

### Resource Reservation Request and Allocation of Session Slots

The “pool” of the session slots consists of a maximum of N*(K-1-P) slots. Each slot can potentially use any session slot from the pool, whereas the control slot and the elastic slots are definitively allocated to a node.

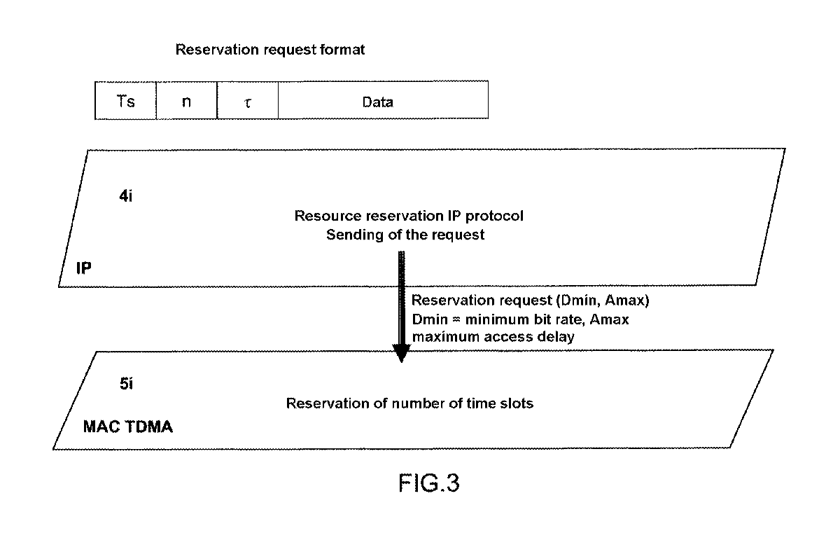

With a new session, the MAC layer 5i of a node 3i (FIG. 3) receives a resource reservation request Res(Dmin, Amax) (broken line arrow in the figure) matched with a minimum bit rate constraint Dmin and a maximum slot Di access delay constraint Amax. The resource reservation request is sent from the protocol layer, in the example, the IP protocol (FIG. 3).

Each slot Di is characterized by an associated individual bit rate Deli. A node Ni can thus assess the number of slots Di that it needs to satisfy the reservation request in terms of bit rate Dmin based on the individual bit rate Deli offered by a slot Di.

It is the medium access layer MAC that effectively allocates the resources corresponding to a resource reservation request for a session. For a given node, this MAC layer chooses the session slots Di of the frame F needed to satisfy the resource reservation request and then, the MAC layer starts appropriate negotiation procedures to reserve the slots belonging to the pool. The MAC layer starts its procedures according to a principle disclosed in the Applicant's Patent Application FR 06 11279. It then reserves, in the allocated slots, the space needed for the MAC packets, that is to say that the method reserves a space corresponding to a number of MAC packets, one slot being able to support a number of MAC packets. The size of an MAC packet is determined by the maximum size of a packet of the application supported by the session, the session being open to the profit of an application. The maximum size is specified in the Tspec object of the Path message.

A number of constraints are taken into account in the slot and MAC packet allocation algorithm:
the resources allocated must be compatible with the minimum bit rate Dmin requirements specified in the reservation request,
the maximum slot access delay Amax must be compatible with the maximum delay imposed in the reservation request.
   Declension of an Overall Resource Reservation, of RSVP type, in the MAC Layer

In order to support the resource reservation request at the MAC level, two parameters are introduced into the MAC request:
τ: the maximum delay required to access a slot,

R: the minimum bit rate required.

These two parameters are used in the resource allocation algorithm, so as to guarantee that the reservation request with service guarantee is observed.

In the case of a periodic TDMA at each node, the Resv message for the RSVP resource request is reflected in the MAC layer by a reservation in terms of number of MAC packets. The RSVP parameters are described according to the IETF's RFC specifications known to those skilled in the art and will not therefore be explained in this patent application.

For example, the parameters used to describe the envelope of the traffic according to the token bucket model are, according to the “token bucket” recommendation RFC 2212 available via the link http://www.faqs.org/rfcs/rfc2212.html.
p=peak rate (octets/sec)
b=bucket capacity (“bucket depth”) (octets)
r=token bucket rate (octets/sec)
m=minimum policed unit (octets)
M=maximum size of the application's data packets (“maximum datagram size”) (octets).

The transmission delays for each node Ni are described by the following two parameters:
Cᵢ=rate dependent factor (octets)
Dᵢ=rate independent term (sec)

Thus, the limit on the transmission delay for a packet at a minimum rate R for the node Ni is:

τᵢ=Cᵢ/R+Dᵢ

In the case of a TDMA protocol with slots that are totally periodic at each node, the RSVP calculation method can be used by establishing a strict correlation between the MAC parameters and the RSVP parameters.

The mathematical relations between the parameters Cᵢ and Dᵢ of the field corresponding to the message of the path that the data will use for the RSVP AdSpec protocol (the PATH message of the RSVP protocol) and MAC level parameters described previously are then as follows:
Cᵢ: size of an MAC packet (octets)
Dᵢ: possible additional delay associated with slot management or with the processing and internal transit of an MAC packet.

For identical nodes, the parameters are independent of the node and no longer need to be indexed.

Note that the relation for the parameter Ci or C is strictly valid only if the allocation leads to a substantially uniform time distribution of the physical slots of each node within the overall frame and if the MAC packets of one and the same session are divided up over distinct physical slots.

The method considers MAC packets of variable size. For a given session, still with predominant latency constraint, the size of the MAC packets reserved will be set to the value M of the maximum application packet size supported.

In this case, when the slots are decoded globally, the parameters of the “Adspec” resource reservation message C and D corresponding to the respective packet size and possible additional delay associated with slot management or with processing and internal transit of an MAC packet parameters then have the values:

C=M maximum packet size

D=Ts+Do

With Do being the possible additional transmission time.

The bit rate consumed at the MAC level for the encapsulation of the packets has not been taken into account in the interests of simplification. To include this encapsulation would amount to considering R to be the useful bit rate for the application.

If we now consider the general case of a session with dual latency and bit rate constraint, without assuming that the latency constraint is predominant, the declension of “RSVP OPWA”, based on an equivalence between latency and bit rate, becomes unsuitable for the applications with predominant bit rate constraint, for which it introduces excessive maximum slot access delay constraints.

In practice, for example, an RSVP request with non-existent latency constraint should be declined in the MAC layer as follows:
Maximum transmission delay required: τ=infinity
Minimum bit rate required: R=r

To process the resource reservation with guaranteed bit rate and latency appropriately for applications for which the predominant constraint is not, a priori, known, or in the case in point, if the latency constraint is low, the method should be able to separately manage the latency and bit rate characteristics. It is then possible to consider an extension of the OPWA mode of the RSVP protocol by adding the following fields:
a field Ts corresponding to the slot duration in the AdSpec object of the resource reservation message,
a field n concerning the number of radio nodes crossed in the AdSpec object of the resource reservation message,
a field τ giving the maximum waiting time for the slot in the Rspec object of the response message to the resource reservation message Resv.

Considering the maximum latency from end-to-end δ, and the maximum slot waiting time τ at each node, the following mathematical relations are established:

In the case where the guaranteed bit rate is less than the peak bit rate R≦p:

$$δ = \frac{( b - M ) ( p - R )}{R ( p - r )} + \frac{M}{R} + {\sum }_{i = 1}^{{n}^{′}} {D}_{i} + n \cdot τ$$

in which n′ is the total number of nodes on the path, possibly greater than the number n of radio nodes on the path given previously.

In the case where the guaranteed bit rate R is greater than the peak bit rate p, R≧p:

$$δ = \frac{M}{R} + {\sum }_{i = 1}^{{n}^{′}} {D}_{i} + n \cdot τ$$

The maximum slot access delay has the value:

τ=T=m.Ts
m being a non-zero integer and Ts the duration of a slot.

The reservation optimization problem is then expressed:
Max m
Min R

In which the maximization of m is considered to take priority over the minimization of the bit rate R subject to the following constraints:

$$δ ( R , τ ) \leq {δ}_{max}$$

$$R \geq r$$

$$R \leq {R}_{max}$$

$$R \geq \frac{M}{τ + {T}_{s}}$$

$$τ = m \cdot {T}_{s}$$

In which Rmax is the maximum acceptable bit rate and δmax the maximum end-to-end latency constraint.

The solution for the optimum (R, m′) is written:

### if Rmax≦p:

$$\begin{matrix}{m}^{′} = min ( ⌊ \frac{{δ}_{max} - {\sum }_{i = 1}^{{n}^{′}} {D}_{i} - \frac{M}{{R}_{max}} - \frac{( b - M ) ( p - {R}_{max} )}{{R}_{max} ( p - r )}}{n \cdot {T}_{s}} ⌋ , N . K ) \\ {R}^{′} = max ( r , \frac{( \frac{b - M}{p - r} ) p + M}{{δ}_{max} - {\sum }_{i = 1}^{n} {D}_{i} - n \cdot {m}^{′} \cdot {T}_{s} + \frac{b - M}{p - r}} )\end{matrix}$$

### if Rmax≧p:

$${m}^{′} = min ( ⌊ \frac{{δ}_{max} - {\sum }_{i = 1}^{n} {D}_{i} - \frac{M}{{R}_{max}}}{n \cdot {T}_{s}} ⌋ , N \cdot K )$$

$${R}^{′} = max ( r , \frac{M}{{δ}_{max} - {\sum }_{i = 1}^{n} {D}_{i} - n \cdot {m}^{′} \cdot {T}_{s}} )$$

The RSVP reservation request is then declined in the MAC layer as follows:
maximum transmission delay required: τ′=m′.Ts with m′ being the number of packets reserved
minimum bit rate required: R′

In various embodiments, the invention notably offers one or more of the following advantages:
optimizing the allocation of the resources for the sessions by reserving session data packets of appropriate size,
guaranteeing a service quality at the node level on the session streams in terms of bit rate, transmission delay and jitter,
making it possible to put in place application service guarantees at the level of the higher layers, in terms of minimum bit rate and maximum latency value for the end-to-end application. These guarantees can be applied to applications with predominant latency constraint but also to applications with predominant bit rate constraint. This is then done by implementing an overall reservation mechanism derived from the RSVP standard protocol, by enriching the “OPWA” mode.

1. A resource reservation method with guaranteed service in terms of minimum bit rate Dmin and maximum access time Amax at the N nodes of a radio network using time slots Di each associated with an individual bit rate Deli for sending and transmitting data, a node of the network comprising a protocol layer and a MAC network access layer, comprising the following steps:
the protocol layer of the node sends a reservation request to the MAC layer of the node;
the source node sending the data introduces into the format of the Path and Resv messages of the RSVP protocol:
a field Ts corresponding to the maximum duration of the time slot observed on the current path in the Adspec reservation request of the Path message, transmitted from the source node to a recipient;
a field n concerning the number of radio nodes crossed in the object of the Path message;
a field τ giving the maximum waiting time for the time slot in the Rspec object of the Resv message corresponding to the response to the reservation request sent by the recipient to the source node; and
the MAC layer of said node reserves the number of time slots Di needed to satisfy the service guarantee recorded in the reservation request.

2. The method as claimed in claim 1, further comprising the steps of implementing a dynamic time slot allocation method for the sessions, then a reservation of the MAC packets for the sessions on the reserved time slots Dᵢ by dynamically adapting the size of the MAC packets to the need of the application.

3. The method as claimed in claim 1, wherein the RSVP reservation request is then declined in the MAC layer as follows:
Maximum transmission delay required: τ′=m′.Ts
Minimum bit rate required: R′
in which Ts corresponds to the duration of a slot and m′ to the number of packets reserved.

4. The method as claimed in claim 1, wherein the network is an ad hoc radio network, and a radio frame includes four layered elements: a basic MAC resource, a time “slot”, a basic frame BF, a frame F, a frame comprising a control slot allocated to a given node transmitting the MAC level signaling, several time slots intended for transmitting elastic data or session packets.

5. The method as claimed in claim 1, wherein the method uses a periodic TDMA at each node.

6. The method as claimed in claim 1, wherein the method is used to modify the format of the messages used in the OPWA mode.

7. The method as claimed in claim 1, wherein the method uses an IP protocol.

8. A network comprising a source node, a recipient node and one or more intermediate nodes, the source node including sending means, Ei, for sending a resource reservation request, the recipient node including means for receiving this request and sending in turn a path reservation message, and the nodes using time slots to send and transmit data, wherein each intermediate node includes a MAC layer and a protocol layer, wherein the protocol layer of the node sends a reservation request to the MAC layer of the node;
the source node sending the data introduces into the format of the Path and Resv messages of the RSVP protocol:
a field Ts corresponding to the maximum duration of the time slot observed on the current path in the Adspec reservation request of the Path message, transmitted from the source node to a recipient;
a field n concerning the number of radio nodes crossed in the object of the Path message;
a field τ giving the maximum waiting time for the time slot in the Rspec object of the Resv message corresponding to the response to the reservation request sent by the recipient to the source node; and
the MAC layer of said node reserves the number of time slots Di needed to satisfy the service guarantee recorded in the reservation request.

9. The network as claimed in claim 8, wherein the network is an ad hoc network.

10. The method as claimed in claim 2, wherein the method is used to modify the format of the messages used in the OPWA mode.
